(19) United States
(12) Patent Application Publication
(10) Pub. No.: US 2019/0048661 A1
(43) Pub. Date: Feb. 14, 2019

(54) A LADDER SUPPORT DEVICE AND A METHOD FOR SECURING A LADDER TO A BASE

(71) Applicant: KUMPREY LLC, Redonodo Beach, CA (US)

(72) Inventor: Troy KUMPREY, Redondo Beach, CA (US)

(21) Appl. No.: 16/077,452

(22) PCT Filed: Feb. 27, 2017
(86) PCT No.: PCT/US17/19781

§ 371 Date: Aug. 11, 2018

Related U.S. Application Data
(60) Provisional application No. 62/426,332, filed on Nov. 25, 2016.

(51) Int. Cl. E06C 7/46; E06C 7/42

(52) U.S. Cl. CPC E06C 7/46; E06C 7/423

(57) ABSTRACT

The invention relates to a ladder support device and a method for securing a ladder to a base. The ladder support device comprises a main body, an insert which is attachable to the main body and which is to be pushed into a base, and an anchor portion configured to secure the ladder to the main body. The method or securing a ladder to a base comprises: providing the ladder support device; attaching the insert to the main body and pushing the insert into the base; arranging a shoe of the ladder into the ladder support device so that the anchor portion acts to secure the ladder.

### CROSS-REFERENCE TO RELATED APPLICATION

The present utility patent application claims the priority benefit of the U.S. provisional application for patent Ser. No. 62/301,585 filed on Feb. 29, 2016,entitled Apparatus and Method for Securing a Ladder and is a National Stage Application of international application serial number. PCT/US17/19781 filed Feb. 27, 2017 which claims the benefit of U.S. provisional application for patent Ser. No. 62/301585 filed on Feb. 29, 2016.

### FIELD OF THE INVENTION

The present invention relates generally to a ladder support and securing device for ladders, scaffolds and the like. More particularly, the invention relates to a ladder support device and a method for securing a ladder to a base, such as ground or a smooth surface on which the ladder may be prone to slippage.

### BACKGROUND OF THE INVENTION

A Consumer Product Safety Commission (CPSC) report on ladder safety concerning the frequency and severity of ladder-related accidents in the United States showed an alarming number of injuries caused by ladder accidents. Every year, thousands of people are injured and hundreds are killed. As an example, more than 90,000 people receive emergency room treatment from ladder-related injuries every year, and almost 700 occupational deaths are caused annually, which contributes to 15% of all the occupational deaths. Even as ladder technology advances, seemingly making users safer, over the last 10 years, the amount of ladder-related injuries has increased 50%.

Many injuries occur due to ladder shoes slipping on the surface they are on. Many ladder shoes have been developed so as to increase the amount of friction between the ladder and the surface where the ladder is on (e.g., cement, blacktop, concrete, grass, din and the like).

Ladder support devices are generally known in the art. For example, U.S. Pat. No. 8,042,651 to Michnik etc. teaches a portable ladder support device for supporting a ladder having two side rails connected by spaced rungs. The portable ladder support device comprises at least one handling member, a plurality of support elements, and a frame including a fixating means, a release means, a plurality of guides for guiding movements of the support elements along predetermined trajectories, and a ladder support area for temporary positioning the ladder thereon by bottom ends of the two side rails, wherein each of the plurality of support elements is longitudinal. However, this portable ladder support device and others like it are unduly complex and may still be prone to slippage.

Simpler known ladder support devices include swivel shoes with ice pick like protrusions from the bottom of the shoe at both ends for stability. Other devices, such as the one described in US Patent Publication No. 5086876A to Severson, describe a foot actuated ladder brace for stabilizing ladders with side rails, which operates by increasing the ladder base width. The foot actuated ladder brace comprises a channel shaped foot link with inner and outer ends, the inner end being pivotally connected to the bottom of one of the ladder side rails as to fold up along the side rail and to swing downwardly to extend along and to increase the ladder base. While this approach stabilizes a ladder, it increases footprint of the ladder and requires a larger space, which is undesirable. Also, this approach insufficiently secures the ladder to the base in some cases.

Therefore, what is needed is a ladder support device to ensure that the ladder is sufficiently secured to a base, namely, a single device for both soft malleable surfaces and hard surfaces. Also, an effective method for securing a ladder to a base is needed.

### BRIEF SUMMARY OF THE INVENTION

To achieve the forgoing and other aspects, and in accordance with the purpose of the invention, a ladder support device as well as a method for securing a ladder to a base are presented herein. The ladder support device is compact and in some embodiments collapsible for ease of transport.

In one aspect, a ladder support device is provided, comprising: a main body; an insert which is attachable to the main body and which is to be pushed into a base; and an anchor portion configured as a backstop for a ladder. In other embodiments, the insert may comprise a U-shaped staple having one or more leg pieces. The anchor portion may comprise a part of the insert. The main body may comprise a platform and one or more sidewalls extending from the platform. The anchor portion may comprise a part of the platform and/or a part of the sidewalls. A grip section may be provided on top of the platform to act as the anchor portion. In addition, a handle may be provided at the main body. The anchor portion may comprise a part of the handle.

In still other embodiments, a carriage may be provided at the main body to hold the insert. The main body may comprise a raised portion with one or more apertures dimensioned for ladder rung connectors. A connection member may be provided at the main body to connect the ladder support device to the ladder. The connection member may comprise a bearing operably engaged to an end of an arm to allow for a pivoted or circular rotation, the other end of the arm being operably engaged to the ladder to allow for a pivoted or circular rotation. The arm may comprise a bearing positioned proximate a middle portion thereof, to allow the arm to extend and collapse.

In operation, the insert attached to the main body of the device are pushed into a base, for example a myriad of objects that are part of the user's environment such as a grass or a concrete base, and therefore the ladder support device would not be prone to slippage on the base. In addition, since a part of the main body (i.e., the platform or the sidewall) or the insert serves as a backstop for the ladder arranged into the ladder support device, the ladder would also not be prone to slippage on the device. As a result, the slippage of the ladder with respect to the base can be prevented, and the safety and stability of the ladder can be improved.

In another aspect, a method for securing a ladder to a base is provided, comprising: providing a ladder support device as described above; attaching the insert to the main body and pushing the insert into the base; and arranging a shoe of the ladder into the ladder support device, so that the anchor portion acts as a backstop for the shoe.

In other embodiments, a handle may be provided at the main body, and the method may further comprise fastening the ladder to the handle via a strap. The main body may comprise a raised portion with one or more apertures dimensioned for ladder rung connectors, and the method may further comprise attaching a ring of the ladder to the main body via the ladder rung connectors. Additionally, the ladder support device may comprise a connection member connected to the ladder via an arm, an end of the arm being operably engaged to the connection member and the other end of the arm being operably engaged to the ladder, so as to allow for a pivoted or circular rotation, and the method may comprise folding the ladder support device into the ladder after use.

Other features, advantages, and aspects of the present invention will become more apparent and be more readily understood from the following detailed description, which should be read in conjunction with the accompanying drawings.

### BRIEF DESCRIPTION OF THE DRAWINGS

The foregoing aspects and other features of the present invention are illustrated by way of example, and not by way of limitation, in the accompanying drawings, in which like reference numerals refer to similar elements and in which:

FIG. 1 illustrates a perspective view of a ladder support device in accordance with an embodiment of the present invention;

FIG. 2 illustrate a perspective view of the ladder support device of FIG. 1 in its grounded position;

FIG. 3 illustrate a perspective view of the ladder support device of FIG. 1 together with a ladder supported by the device;

FIG. 4 illustrates a bottom view of the ladder support device of FIG. 1;

FIG. 5 illustrates a perspective view of a ladder support device in accordance with another embodiment of the present invention;

FIG. 6 illustrates a side view of the ladder support device of FIG. 5 in its grounded position;

FIG. 7 illustrates a perspective view of the ladder support device of FIG. 5 together with a ladder supported by the device;

FIG. 8 illustrates a perspective view of the ladder support device of FIG. 5 together with a ladder, where the ladder support device is folded into the ladder; and

FIG. 9 is a flow chart illustrating a step wise embodiment of the present invention.

### DETAILED DESCRIPTION OF THE INVENTION

The present invention is best understood by reference to the detailed figures and description set forth herein.

Embodiments of the invention are discussed below with reference to the figures. However, those skilled in the art will readily appreciate that the detailed description given herein with respect to these figures is for explanatory purposes only, as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the invention is not limited to the particular methodology, compounds, materials, manufacturing techniques, uses and applications, described herein, as these may vary. It is also to be understood that the terminology used herein is used for the purpose of describing particular embodiment only, and is not intended to limit the scope of the present invention. It must be noted that as used herein and in the appended claims, the singular forms “a”, “an”, and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, ail technical and scientific terms used herein have the same meanings as commonly understood by one of ordinary skill in the an to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

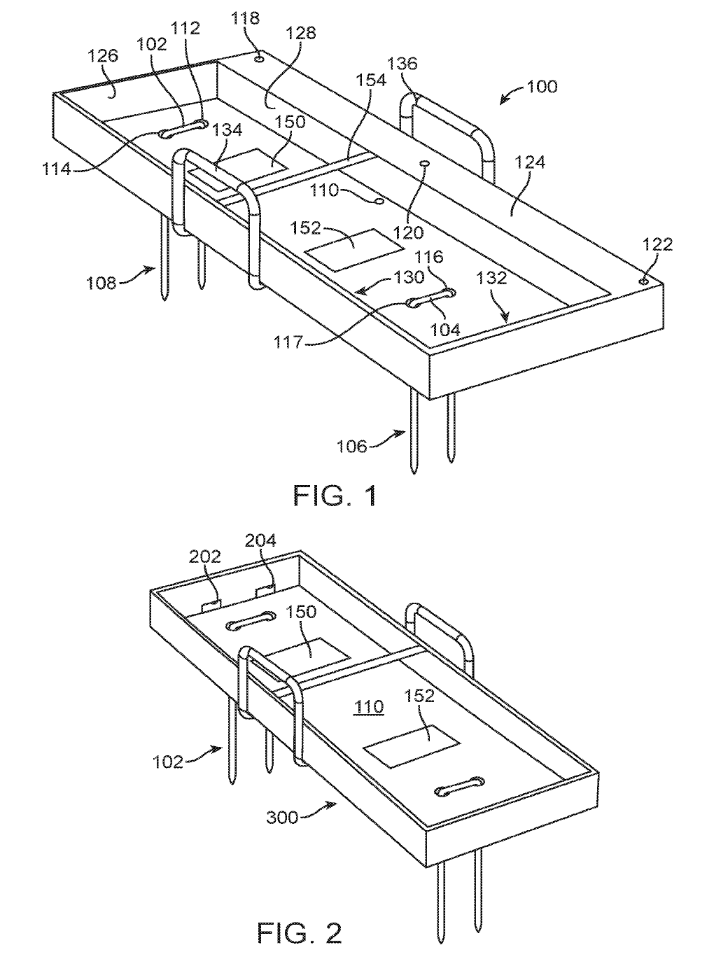

Referring now to FIG. 1, a ladder support device is shown generally at 100. The ladder support device 100 comprises a platform 110 and a plurality of sidewalls 126, 128, 130 and 132 which extend upwardly from the platform 110 and which are connected to the platform 110 at an approximate right angle. The platform and sidewalls may collectively be referred to as a main body of the device herein. In this view, the ladder support device 100 comprises generally U-shaped staples 102 and 104. U-shaped staples 102 and 104 comprise leg pieces. The leg pieces provided at 106 and 108 can be seen in this figure, while other congruent leg pieces cannot be seen in this view, since they are hidden by the platform 110 in the view path. These leg pieces may be provided with spikes at their ends facing the base, for ease of insertion into the base. The platform 110 comprises at least four apertures 112, 114, 116 and 117, which are dimensioned to accept the leg pieces 106 and 108. This may occur via wing nut or other screw and nut configuration, and also via snap fit, friction fit, press fit and the like. Owning to the ease of removability, the leg pieces are replaceable based on the type of ground where the ladder support device will be set onto. As an example, if the ground is soft dirt or grass, the user will select a type of leg piece having a spike and having a dimension that is thick, preferably. However, if the ground is concrete or cement, a much thinner leg piece with no spike is preferable because the user only has to make a small drill bit hole into the cement or concrete, which is easily scalable. In optional embodiments, the platform 110 may be a solid base formed of such as metal or aluminum or hard plastics and the like.

The platform 110 may further comprise grip sections 150 and 152 on the upper surface of the platform 100 dimensioned for retaining the shoes of a ladder. The grip sections 150 and 152 may comprise a rubberized section, or sheet of paper or fabric with adhesive on one side and a surface similar to fine sand paper on the other. The grip sections 150 and 152 allow the shoes of a ladder to stick firmly to the surface of the base 110.

Handles 134 and 136 are integrally formed with two opposing sidewalls 128 and 130 of the ladder support device 100, respectively, and extend beyond these sidewalls, as shown. In other embodiments, the handles may be detachably fixed to the side walls, and one or more handles may be provided at one single sidewall., such as at the sidewall 130. Handles 134 and 136 function to perform multiple duties. For example, they may make the ladder support device 100 easier to carry. Also, they may act as foundations for attachment members such as a strap or rope (not shown) to a ladder. Although a U-shaped handle is shown herein, if is to be understood that many other shapes (such as V-shape, J-shape) may be employed by the handle. A further center push handle 154 is provided adjacent to the long rails of the device 100, and is configured to allow the user to use a single hand to push and pull the device into and out of a surface. The center push handle 154 connects a center portion of the sidewall 130 to a center portion of the sidewall 128.

In optional embodiment of the present invention, the ladder support device 100 comprises a raised portion 124 on the plat form 110. The raised portion 124 extends above the platform 110 adjacent to the sidewall 128 and has a height equivalent to that of the sidewall 128. In other embodiments, the height of the raised portion 124 may be larger or smaller than that of the sidewall 128. One or more raised portions may be provided proximate other sidewalls 126, 130 and 132, or even on an intermediate part of the platform 110 between two of sidewalls 126, 128, 130 and 132. In addition, the raised portion 124 may simply bean extension of the sidewall 128 in its thickness direction. Due to a relatively larger thickness, the raised portion 124 may serve as backing for the sidewall 128, when the side wall 128 acts as a anchor for the ladder, and may be referred to as the support portion herein. Also, sidewalls 126, 128, 130 and 132 may be formed with a rib protruded from an inner or outer surface thereof, to provide additional support. This anchoring portion is particularly useful when the ladder support device is at an angle, such that the ladder shoes should abut the surface to provide stabilization for the shoes. Under normal operating conditions, the shoes need not anchor the support portion due to the grip section 150 and 152.

The raised portion 124 is shown as comprising several apertures 118, 120 and 122 formed therein. The apertures 118, 120 and 122 are dimensioned for ladder rung connectors, which are used to connect the ladder rungs to the ladder support device.

In operation, the sidewalls 128 and/or 130 will act as a anchor to the ladder shoe, so as to provide a secure connection to the ground and to avoid any and all slippage that could occur, thereby preventing injury with an extremely high degree of certainty.

In another embodiment according to the invention, the ladder support device 100 may not comprise sidewall(s) extending from the platform. That is to say, sidewalls 126, 128, 130 and 132 are omitted from the embodiment shown in FIG. 1. Also, the handles 134, 136 and the raised portion 124 may also be omitted. In this way, the resulting ladder support device will comprise a platform and a U-shaped staple having leg piece attachable to the platform. The platform is formed with an aperture to receive the leg piece. In operation, the leg piece is attached to the platform through the aperture, with one end extending upwardly beyond the platform and the other end extending downwardly beyond the platform. A section of the leg piece extending downwardly beyond the platform will be pushed into a base, such as a grass or a concrete base, while another section of the leg piece extending upwardly beyond the platform will act as a anchor to the ladder shoe. Preferably, two leg pieces are attached to one side of the platform, with a gap between the two leg pieces being smaller than a diameter of the ladder shoe, so as to provide a secure and stable support. The length of the leg piece extending upwardly beyond the platform can be adjusted by threading the leg piece into the aperture formed in the platform, and leg pieces with a variety of length can be employed. Accordingly, the ladder support device can rest on a myriad of objects that are part of the user's environment and can also be used with a variety of ladders. In addition, the handles 134, 136 may act as a anchor to the ladder shoe, when there is no sidewall or leg piece functioning to abut the ladder shoe.

FIG. 2 illustrates a perspective view of the ladder support device of FIG. 1 in its grounded position, showing how the ladder support device is installed into the ground. Leg pieces cannot be seen, since they have been pushed into the ground. In a case where the ground is soft dirt or grass, a user can simply push the leg pieces of the device into the ground with minimal force, especially when spikes are provided on the end of the leg pieces. Or, in a concrete or hard ground, a user can simply drill a small hole into the ground and slip the leg pieces of the device into the hole. Once the staples 102 and 104, are inserted into the ground, the ladder support device 100 will be prevented from slippage on the ground. In some embodiments, the platform 110 may further comprise an elastomeric ground-gripping tread on its underside, so that when a whole length of the leg pieces is pushed into the ground and the underside of the platform is in direct contact with the ground, significant friction will occur between the ground and the platform, thus further stabilizing the ladder support device and preventing slippage thereof. The ground-gripping tread is shown in FIG. 4 generally at 162 and 164.

With reference now to FIG. 4, a bottom view of the ladder support device 100 of FIG. 1 is shown. The leg pieces 106 and 108 can be seen protruding through the bottom surface 160, and washer and nut can be seen in their tightened positon. Ground-gripping tread 162 and 164 may be affixed to the bottom of the device 100, on its underside, so that in optional embodiments, U-shaped staples are not required due to significant friction between the ground and the platform 100 while stabilizing the ladder support device and preventing slippage thereof.

Referring back to FIG. 2, the ladder support device 100 may further comprise a carriage comprising snaps 202 and 204 for receiving and holding the U-shaped staples and the ladder rung connectors. The carriage snaps may be integrally manufactured with or detachably fixed to the platform 110 or the sidewalls 126, 128, 130 and 132 and provide a friction or snap fit.

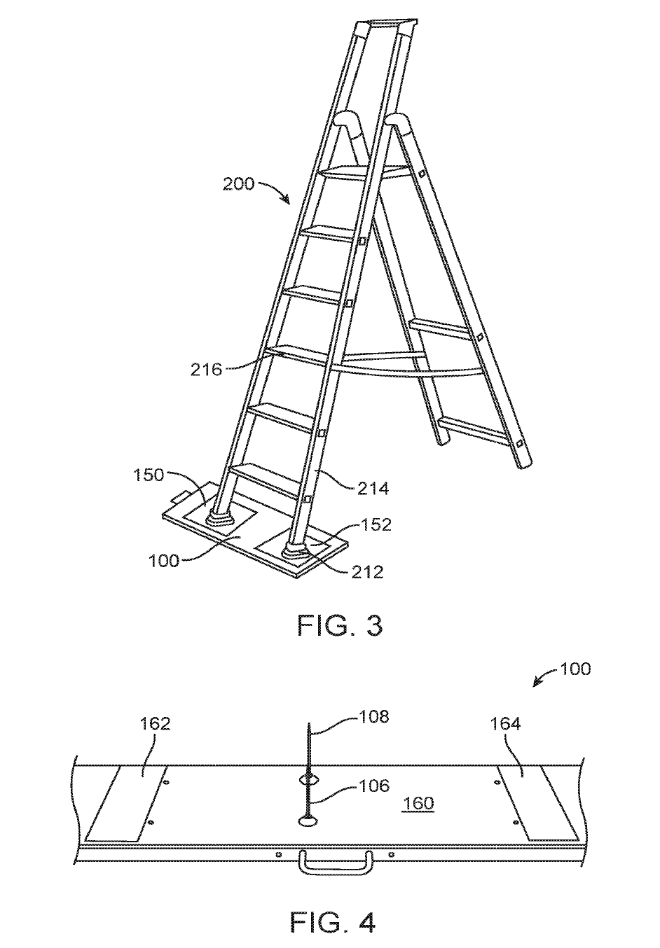

Turning to FIG. 3, a perspective view of the ladder support device of FIG. 1 together with a ladder supported by the device is illustrated. The ladder is shown at generally 200, comprising two longitudinal side rails 214 and a plurality of horizontal steps (rungs) 216 connected between the side rails 214. The ladder 200 further comprises a top platform proximate the top of side rails 214 for the user to stand thereon, and a stabilizing brace pivotally connected to the top platform and to the side rails. Also, one or more flexible ropes are connected to the stabilizing brace and to the side rails, so as to limit a maximum angle there between, preventing the user on the top platform from undergoing a sudden fall. In operation, after leg pieces of the ladder support device are pushed into the ground, a shoe 212 of the ladder 200 is arranged into the ladder support device, such as into a space surrounded by the sidewalls 126, 128, 130 and 132 shown in FIG. 1, and on top of grip portion 150 and 152. The shoe 212, in some embodiments, abuts against one sidewall, and is prevented from slippage on the platform of the ladder support device in a direction toward the sidewall. In other embodiments, the shoes simply rest on the high friction surface of the grips 150 and 152. Two shoes 212 of the ladder 200 may be arranged into one single ladder support device, or into two separate ladder support devices, depending on actual requirements.

In an embodiment where the U-shaped staples 102 and 104, rather than the sidewall, act as a anchor to the ladder shoe, as described above, after the leg pieces are partially pushed into the ground, the ladder shoe is arranged on the platform of the ladder support device to abut against a section of the leg pieces extending upwardly beyond the platform. A strap may be used to fasten the ladder shoe to the section of the leg pieces, so as to provide further fixation. In other embodiments where a handle is provided at the platform or sidewalls, a strap may also be used to fasten the ladder shoe to the handle

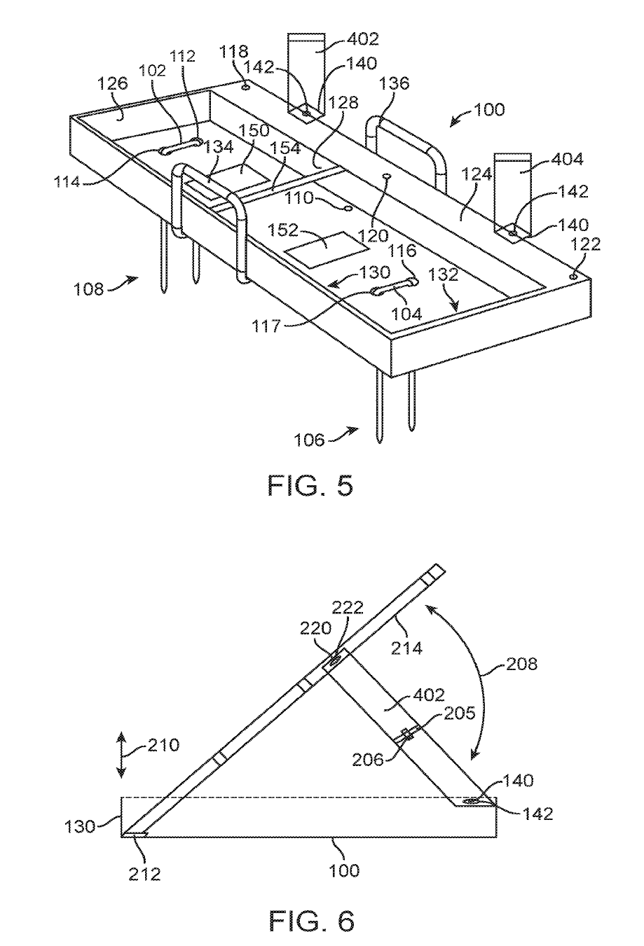

Referring now to FIG. 5, a ladder support device 100 in accordance with another embodiment of the invention is illustrated. The ladder support device 100 comprises all the components of the ladder support device shown in FIG. 1, and additionally includes one or more connection members 140 for attachment to a ladder, such as two side rails of the ladder. As shown, two connection members 140 are provided at the raised portion 124 above the platform 110 adjacent to the sidewall 128. In other embodiments, one or more connection members may be provided at the sidewall 126, 128, 130 or 132, or even at the handle 134 or 136. The connection member 140 may comprise a bearing 142, which is configured to be connectable to an arm 402 and 404 so as to provide an ability of folding the ladder support device 100 up into the ladder 200. Alternatively, the connection member 140 may simply include a buckle or a rope loop which can be removed and hung on a hook arranged at the ladder. The arms may comprise loops or hooks for mating to the rings or side rails of the ladder 200.

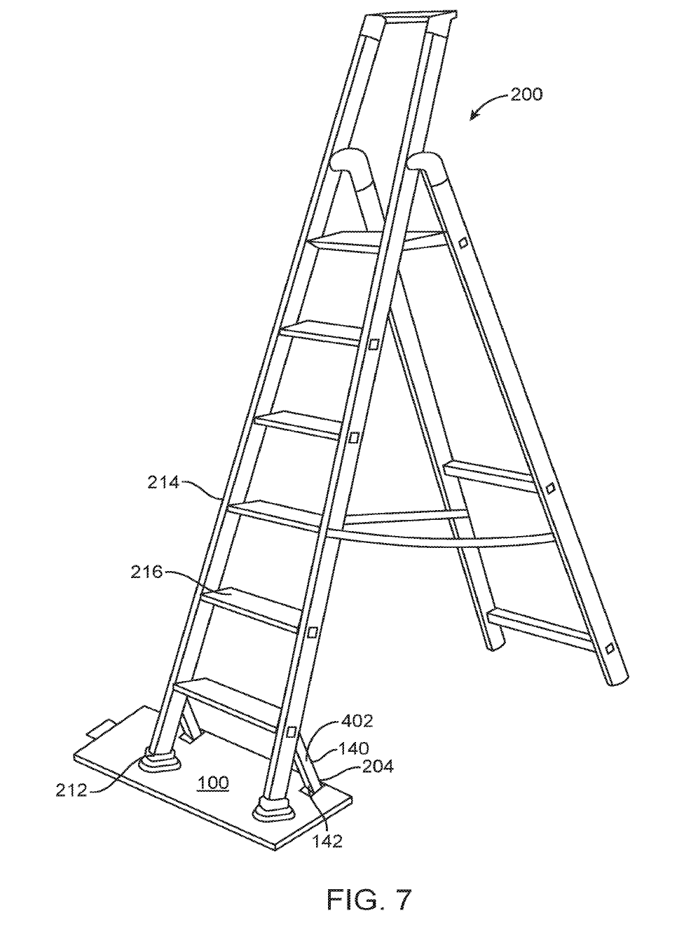

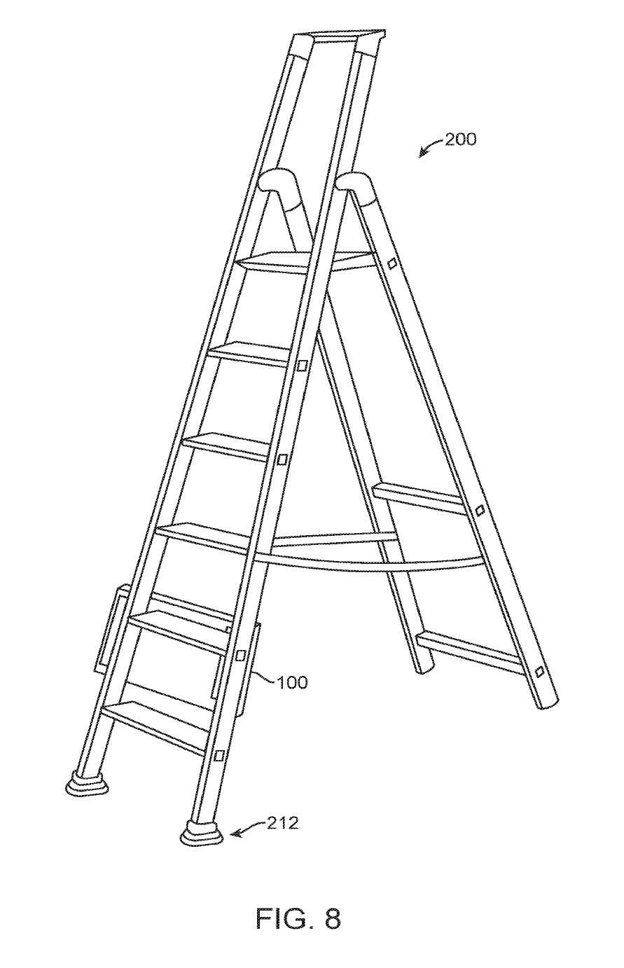

FIG. 6 illustrates a side view of the ladder support device of FIG. 5 in its grounded position where the leg pieces of the device have been pushed into a base, and FIG. 7 illustrates a perspective view of the ladder support device together with a ladder supported by the device. As shown in FIG. 6, a bearing 142 of the connection member 140 is operably engaged to an arm 402 at its first end, providing a pivoted or circular rotation. In this way, the arm 402 is freely rotatable with respect to the ladder support device 100 around an axis defined by a line connecting two bearings 142 (see FIG. 7). A side rail 214 of the ladder 200 is also provided with a ladder connection member 220, which comprises a bearing 222 that is operably engaged to the arm 402 at its second end so as to provide a pivoted or circular rotation. In this way, the arm 402 is capable of rotation with respect to both the ladder 200 and ladder support device 100, so that the ladder support device 100 can be folded up into the ladder 200 after use, such as along a direction indicated at 208. The arm 402 may be accommodated within a space defined between a forward sidewall 130 and a rear side wall 128. In other embodiments, one or two of the bearings 142 and 222 may be provided at an end of the arm 402, so long as the desirable pivoted or circular rotation is available.

In operation, the arm 402 is released from its folded position along a side rail 214 of the ladder 200, such that the arm 402 is allowed for a free rotation with respect to the ladder 200 and the ladder support device is also allowed for a free rotation with respect to the arm 402. A shoe 212 of the ladder 200 is then arranged into the ladder support device 100, so that it abuts against one of the sidewalls 126, 128, 130 and 132 shown in FIG. 1 or a section of leg pieces extending upwardly beyond the platform 110. Thereafter, the leg pieces of the ladder support device 100 are pushed into a base 300, such as a grass or a concrete base, in a vertical direction indicated at 210. In this manner, the ladder shoe 212 engaged with the sidewall 130, and the bearings 142 and 222 constitutes a stable triangle form, and therefore the ladder 200, ladder support device 100 and arm 402 are not able to move with respect to each other. In addition, since the ladder support device 100 is firmly secured to the base 300 via a number of leg pieces, the ladder 200, ladder support device 100 and arm 402 as a whole cannot easily move on the base 300. In other embodiments, a locking mechanism is provided to retain the arm 402 in an orientation as shown in FIG. 5. For example, a pivot pin may extend through the bearing 222 and/or 142 and engage with the arm 402. Also, a brace or locking mechanism may be further provided to retain the device 100 in its folded position along the ladder side rail 214.

The arm 402 itself may comprises a bearing 205, which is positioned proximate a middle portion of the arm 402. The bearing 205 is configured to allow the arm 402 to extend laterally and to collapse, so as to effect outward biasing of the device 100 and also a corresponding inward biasing upon the application of force. A section of the arm 402 on one side of the bearing 205 proximate the ladder support device 100 may be a channel-shaped link, and another section of the arm 402 on the other side of the bearing 205 may be a smaller channel-shaped link adapted within the former link. When the two sections of the arm 402 are aligned in a line, a pin 206 may pass through the bearing 205 and engage with both sections. Thereby, the arm 402 is locked in an orientation as shown in FIG. 5. In other embodiments, the bearings 142, 204 and 212 may be provided with a camming face and effectively acts as a one-way stop as a predetermined point. The arm 402 may be a telescopic member comprising two components, one of which is pivotally coupled with the ladder support device 100 and the other is pivotally coupled with the ladder 200. Due to the telescopic property, an angle between the side rail 214 of the ladder 200 and a surface of the base is adjustable. Once the angle is adjusted to a desired value, a pin may laterally pass through both components, so that they cannot move with respect to each other and the ladder is retained in a desired orientation.

In FIG. 7, for the sake of orientation, the arm 402 is shown together with connection members, and only one arm 402 connected to one side rail is shown. Although two shoes 212 of side rails 214 of the ladder 200 are shown as having been arranged into a single ladder support device 100, it is to be understood that the two shoes 212 may be arranged into two separate ladder support devices 100 in other embodiments.

Turning to FIG. 8, the ladder support device 100 is shown in its folded state, i.e., in a non-grounded position. The ladder support device 100 is secured adjacently to the ladder side rails 214 proximate the steps (rungs) 206 connected between side rails 214 to allow for easy transport. For the purpose of orientation, the arm 402 is not visible since they have been folded up behind and into the device 100, and are hidden by the ladder side rails 214.

A method for securing a ladder to a base in accordance with the present invention may comprises: providing a ladder support device as described above; pushing leg pieces of a staple through apertures in the main body (i.e., platform or side wall of the device); pushing the leg pieces into the base; and arranging a shoe of the ladder into the ladder support device, so that the sidewall or section of the leg pieces extending beyond the platform acts as a backstop for the shoe. While the method is described in an exemplary step-by-step manner, it is to be appreciated that a skilled artisan may rearrange or reorder the steps of the method while maintaining like results.

When a user is intended to move the ladder 200 after use, he/she may lift up the shoe 212 off the base 300 in a vertical direction 210. Thereafter, the user may pull leg pieces of the ladder support device 100 out of the base 300, with minimal force, and finally fold the device 100 up into the ladder 200 as shown at arrow 208 (referring to FIG. 6) in the case where an arm 402 is employed.

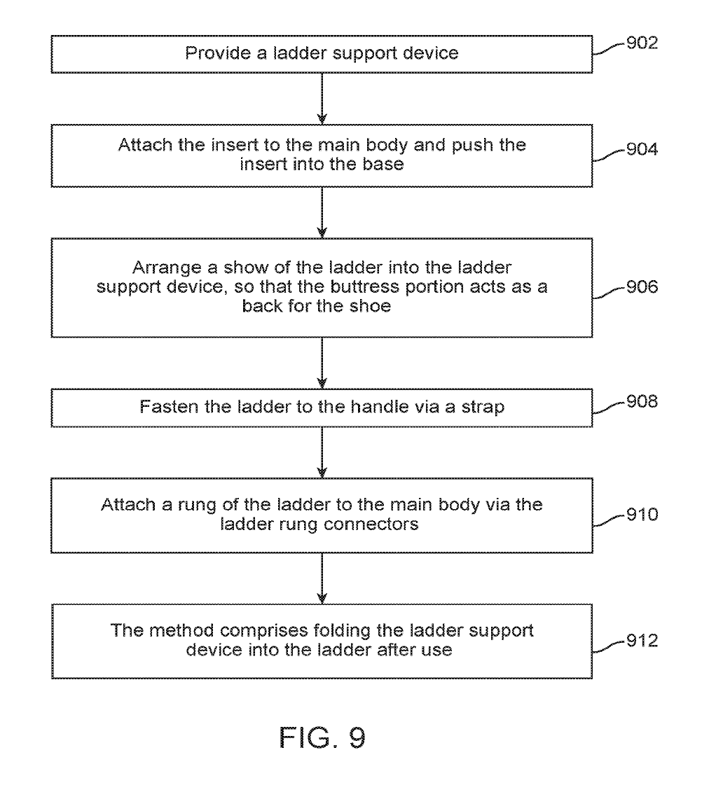

Referring now to FIG. 9, a stepwise flow chart showing a method for securing a ladder to base is provided. The method comprises providing a ladder securing device such as that shown in FIGS. 1-8, step 902. The method further comprises attaching the insert to the main body and pushing the insert into the base, step 904. The method further comprises arranging a shoe of the ladder into the ladder support device, so that the platform acts as a support for the show, step 906. The method further comprises fastening the ladder to the handle via a strap step 908. In optional embodiments, the method further comprises attaching a rung of the ladder to the main body via the ladder rung connector, step 910. The method further comprises folding the ladder support device into the ladder after use, step 912.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

We claim:

1. A ladder support device, comprising:
a main body;
an insert which is attachable to the main body and which is to be pushed into a base; and
an anchor portion configured to secure the ladder to the main body.

2. The ladder support device according to claim 1, wherein the insert comprises a U-shaped staple having one or more leg pieces.

3. The ladder support device according to claim 1, wherein the anchor portion comprises a part of the insert.

4. The ladder support device according to claim 1, wherein the main body comprises a platform and one or more sidewalls extending from the platform.

5. The ladder support device according to claim 4, wherein the anchor portion comprises a part of the platform and/or a part of the sidewalls

6. The ladder support device according to claim 4, a grip section is provided on top of the platform to act as the anchor portion.

7. The ladder support device according to claim 1, wherein a handle is provided at the main body

8. The ladder support device according to claim 7, the anchor portion comprises a part of the handle

9. The ladder support device according to any of claims 1, wherein a carriage is provided at the main body to hold the insert.

10. The ladder support device according to any of claims 1, wherein the main body comprises a raised portion with one or more apertures dimensioned for ladder rung connectors

11. The ladder support device according to any of claims 1, wherein a connection member is provided at the main body to connect the ladder support device to the ladder.

12. The ladder support device according to claim 11, wherein the connection member comprises a bearing operably engaged to an end of an arm to allow for a pivoted or circular rotation, the other end of the arm being operably engaged to the ladder to allow for a pivoted or circular rotation.

13. The ladder support device according to claim 12, wherein the arm comprises a bearing positioned proximate a middle portion thereof, to allow the arm to extend and collapse.

14. A method for securing a ladder to a base, comprising;
providing a ladder support device;
attaching the insert to the main body and pushing the insert into the base;
arranging a shoe of the ladder into the ladder support device, so that the anchor portion acts as a backstop for the shoe.

15. The method for securing a ladder to a base according to claim 14, wherein a handle is provided at the main body, and wherein the method further comprises fastening the ladder to the handle via a strap.

16. The method for securing a ladder to a base according to claim 14, wherein the main body comprises a raised portion with one or more apertures dimensioned for ladder rung connectors, and wherein the method further comprises attaching a rung of the ladder to the main body via the ladder rung connectors.

17. The method for securing a ladder to a base according to any of claims 16, wherein the ladder support device comprises a connection member connected to the ladder via an arm, an end of the arm being operably engaged to the connection member and the other end of the arm being operably engaged to the ladder, so as to allow for a pivoted or circular rotation, and wherein the method comprises folding the ladder support device into the ladder after use.
